(19) United States
(12) Patent Application Publication
(10) Pub. No.: US 2011/0030391 A1
(43) Pub. Date: Feb. 10, 2011

(54) Mechanical Defrosting During Continuous Regasification of a Cryogenic Fluid Using Ambient Air

(75) Inventor: Solomon Aladja Faka, Alfred Cove (AU)

Correspondence Address: EDELL, SHAPIRO & FINNAN, LLC, 1901 RESEARCH BOULEVARD, SUITE 400, ROCKVILLE, MD, 20850, US

(73) Assignee: Woodside Energy Limited, Perth (AU)

(21) Appl. No.: 12/536,564

(22) Filed: Aug. 6, 2009

(51) Int. Cl. F17C 9/02

(52) U.S. Cl. 62/50.2

(57) ABSTRACT

A process and corresponding apparatus for regasifying a cryogenic liquid to gaseous form includes a process step and suitable structure to transfer heat from ambient air to the cryogenic liquid across a heat transfer surface by circulating the cryogenic liquid or an intermediate fluid through an atmospheric vaporizer, where the ambient air and the cryogenic fluid or intermediate fluid are not in direct contact; and a process step and suitable structure to mechanically scrape an external portion of the heat transfer surface exposed to the atmosphere to remove frost from the external portion of the heat transfer surface, where defrosting is achieved without the need to discontinue circulating the cryogenic fluid or the intermediate fluid through the atmospheric vaporizer.

### FIELD

The present invention relates to a process and apparatus for regasification of a cryogenic liquid which relies on ambient air as the primary source of heat for heating and or vaporization and which is capable of being operated on a continuous basis. The present invention relates particularly, though not exclusively, to a process and apparatus for regasification of LNG to natural gas using ambient air as the primary source of heat for vaporization.

### BACKGROUND

Natural gas is the cleanest burning fossil fuel as it produces less emissions and pollutants than either coal or oil. “Natural Gas” (NG) is routinely transported from one location to another location in its liquid state as “Liquefied Natural Gas” (LNG). Liquefaction of the natural gas makes it more economical to transport as LNG occupies only about 1/600th of the volume that the same amount of natural gas does in its gaseous state. Transportation of LNG from one location to another is most commonly achieved using double-hulled ocean-going vessels with cryogenic storage capability referred to as Liquefied Natural Gas Carriers (LNGCs). LNG is normally regasified to natural gas before distribution to end users through a pipeline or other distribution network at a temperature and pressure that meets the delivery requirements of the end users. Regasification of the LNG is most commonly achieved by raising the temperature of the LNG above the LNG boiling point for a given pressure.

Large scale regasification of LNG is generally conducted using one of the following three types of vaporizers: an open rack type, an intermediate fluid type or a submerged combustion type.

Open rack type vaporizers typically use sea water as a heat source for the vaporization of LNG. These vaporizers use once-through seawater flow on the shell side of a heat exchanger as the source of heat for the vaporization. They do not block up from freezing water, are easy to operate and maintain. They are widely used in Japan. Their use in the USA and Europe is limited and economically difficult to justify for several reasons. First the present permitting environment does not allow returning the seawater to the sea at a very cold temperature because of environmental concerns for marine life. Also coastal waters like those of the southern USA are often not clean and contain a lot of suspended solids, which could require filtration. With these restraints the use of open rack type vaporizers in the USA is environmentally and economically not feasible.

Instead of vaporizing liquefied natural gas by direct heating with water or steam, vaporizers of the intermediate fluid type use glycols, propane, fluorinated hydrocarbons or like fluids having a low freezing point. The intermediate fluid is heated with hot water or steam first and then used for the vaporization of liquefied natural gas in a second heat exchanger. Vaporizers of this type are less expensive to build than those of the open rack-type but require heating means, such as a burner, for the preparation of hot water or steam and are therefore costly to operate due to fuel consumption.

Vaporizers of the submerged combustion type comprise a tube immersed in water which is heated with a combustion gas injected thereinto from a burner. Like the intermediate fluid type, the vaporizers of the submerged combustion type involve a fuel cost and are expensive to operate. Evaporators of the submerged combustion type comprise a water bath in which the flue gas from a gas burner is injected directly into the water bath and heats up the water in which is installed the exchanger tube bundle for the vaporization of the liquefied natural gas. The liquefied natural gas flows through the tube bundle. Evaporators of this type are reliable and of compact size, but they involve the use of fuel gas and thus are expensive to operate.

It is known to use ambient air or “atmospheric” vaporizers to vaporize a cryogenic liquid into gaseous form for certain downstream operations. An atmospheric vaporizer is a device which vaporizes cryogenic liquids by employing heat absorbed from the ambient air. Ambient air vaporization technology is selected for LNG regasification operations in order to reduce fuel gas consumption for regasification operations and to meet local air emissions standards.

For example, U.S. Pat. No. 4,399,660, issued on Aug. 23, 1983 to Vogler, Jr. et al., describes an ambient air vaporizer suitable for vaporizing cryogenic liquids on a continuous basis. This device employs heat absorbed from the ambient air. At least three substantially vertical passes are piped together. Each pass includes a center tube with a plurality of fins substantially equally spaced around the tube.

U.S. Pat. No. 5,251,452, issued on Oct. 12, 1993 to L. Z. Widder, discloses an ambient air vaporizer and heater for cryogenic liquids. This apparatus utilizes a plurality of vertically mounted and parallelly connected heat exchange tubes. Each tube has a plurality of external fins and a plurality of internal peripheral passageways symmetrically arranged in fluid communication with a central opening. A solid bar extends within the central opening for a predetermined length of each tube to increase the rate of heat transfer between the cryogenic fluid in its vapor phase and the ambient air. The fluid is raised from its boiling point at the bottom of the tubes to a temperature at the top suitable for manufacturing and other operations.

U.S. Pat. No. 6,622,492, issued Sep. 23, 2003, to Eyermann, discloses apparatus and process for vaporizing liquefied natural gas including the extraction of heat from ambient air to heat circulating water. The heat exchange process includes a heater for the vaporization of liquefied natural gas, a circulating water system, and a water tower extracting heat from the ambient air to heat the circulating water. U.S. Pat. No. 6,644,041, issued Nov. 11, 2003 to Eyermann, discloses a process for vaporizing liquefied natural gas including passing water into a water tower so as to elevate a temperature of the water, pumping the elevated temperature water through a first heater, passing a circulating fluid through the first heater so as to transfer heat from the elevated temperature water into the circulating fluid, passing the liquefied natural gas into a second heater, pumping the heated circulating fluid from the first heater into the second heater so as to transfer heat from the circulating fluid to the liquefied natural gas, and discharging vaporized natural gas from the second heater.

The reason why atmospheric vaporizers are not generally used for continuous service is because a solid layer of ice builds up on the outside surfaces of the atmospheric vaporizer, rendering the unit inefficient after a sustained period of use. When an atmospheric vaporizer is used on an intermittent basis, the buildup of the solid layer of ice is generally not a problem, as the ice melts off when the unit is taken off-line. However, when the atmospheric vaporizer is required to operate on a continuous basis, the vaporizer is rendered inefficient after a sustained period of operation as the solid layer of ice reduces the effective surface area of heat transfer for the vaporizer and acts as insulation, reducing the rate of heat transfer from the ambient air to the cryogenic fluid. As the efficiency of the atmospheric vaporizer decreases, either the exit flow rate or the exit temperature of the gas or both decrease. Also, the heat capacity of air is low relative to heat transfer fluids, requiring a lot of vaporizers and plot space for a high capacity regasification operation. For these reasons, atmospheric vaporizers are generally not preferred for continuous vaporization of stored cryogenic liquids.

The rate of accumulation of the solid layer of ice on the external fins depends largely on the relative humidity of the air and on the differential in temperature between ambient temperature and the temperature of the cryogenic liquid inside of the tube. Typically the solid layer of ice is thickest on the tubes closest to the inlet, with little, if any, ice accumulating on the tubes near the outlet unless the ambient temperature is near or below freezing. It is therefore not uncommon for an ambient air vaporizer to have an uneven distribution of the solid layer of ice over the tubes which can shift the centre of gravity of the unit and which result in differential thermal gradients between the tubes.

Management of the problem of the build-up of the solid layer of ice has been attempted in several ways. Periodic manual deicing is performed by personnel by applying external hot water jets or steam jets, and by mechanical removal using picks and shovels. The practice is undesirable in that manual action is required and the ice structure is unpredictable. Large sections of falling sheets of ice may injure personnel performing the work and may structurally damage the vaporizer and associated piping. Another technique is to accommodate the solid ice build up on an initial length of bare piping, that is, piping without external fins, which is intended to serve as the primary surface upon which the ice will deposit. This technique is used because bare piping is less costly than the finned piping and can be supported in a less costly array to accommodate high ice build-up. However, an undesirably large amount of bare piping, floor space, and structural support needs to be used, making this technique unattractive.

Ambient air vaporizers are typically provided with wide gaps between the tubes to allow for the solid layer of ice to accumulate on the tubes during operation. By way of example, it is not uncommon for ambient air vaporizers to be designed for up to 15 tons of solid ice accumulation before being taken offline to allow defrosting to occur. During defrosting, LNG supply to the ambient air vaporizers is discontinued whereby at any given time, at most (often two thirds) of the ambient air vaporizers are online heating LNG with the remaining defrosting offline. The use of redundant vaporizers adds to the cost of the regasification facility, whilst also increasing the overall “footprint” or amount of space required for the facility. Yet another prior art solution has been to oversize the regasification facility resulting in reduced average heat transfer loading per vaporizer, thereby increasing the cost and floor space requirement.

For the foregoing reasons, there remains a need for a process and apparatus for regasification of a cryogenic fluid which can operate continuously without requiring redundant vaporizers and which can overcome or at least ameliorate the heretofore decrease in operating efficiency characteristic of atmospheric vaporizers of the prior art.

### SUMMARY OF THE INVENTION

According to a first aspect of the present invention there is provided a process for regasifying a cryogenic liquid to gaseous form, the process comprising the steps of:
(a) transferring heat from ambient air to the cryogenic liquid across a heat transfer surface by circulating the cryogenic liquid or an intermediate fluid through an atmospheric vaporizer, wherein the ambient air and the cryogenic fluid or intermediate fluid are not in direct contact; and,
(b) mechanically scraping an external portion of the heat transfer surface exposed to the atmosphere to remove frost from said external portion of the heat transfer surface, whereby defrosting is achieved without the need to discontinue circulating the cryogenic fluid or the intermediate fluid through the atmospheric vaporizer.

In one form, step (b) comprises applying a shear force to remove a layer of frost that forms, in use, on the external portion of the heat transfer surface exposed to the atmosphere.

Step (b) may be conducted on an intermittent basis or on a continuous basis.

In one form, the vaporizer comprises a plurality of tubes and step (b) comprises mechanically scraping an external portion of the heat transfer surface of each of the plurality of tubes. Alternatively or additionally, each tube includes a plurality of radial fins, and wherein step (b) comprises mechanically scraping an external portion of the heat transfer surface of each of the radial fins.

In one form, the process further comprises the step of applying heat during step (b).

In one form, the intermediate fluid is selected from the group consisting of a glycol, a glycol-water mixture, methanol, propanol, propane, butane, ammonia, a formate, fresh water and tempered water.

In one form, the atmospheric vaporizer comprises a plurality of passes, the passes being spaced apart from one another and arranged in an array. Each pass may have a vertical orientation and adjacent passes are connected in series or parallel or in a combination of series and parallel configurations.

In one form, the cryogenic fluid is LNG.

According to a second aspect of the present invention there is provided an apparatus for regasifying a cryogenic liquid to gaseous form, the apparatus comprising:
an atmospheric vaporizer for transferring heat from ambient air to the cryogenic liquid across a heat transfer surface by circulating the cryogenic liquid or an intermediate fluid through the atmospheric vaporizer, wherein the ambient air and the cryogenic fluid or intermediate fluid are not in direct contact; and,
a mechanical scraper for mechanically scraping an external portion of the heat transfer surface exposed to the atmosphere to remove frost from said external portion of the heat transfer surface, whereby defrosting is achieved without the need to discontinue circulating the cryogenic fluid or the intermediate fluid through the atmospheric vaporizer.

In one form, the mechanical scraper applies a shear force to remove a layer of frost that forms, in use, on the external portion of the heat transfer surface exposed to the atmosphere. The mechanical scraper may be operated on an intermittent basis or a continuous basis depending on the rate of accumulation of frost.

In one form, the mechanical scraper is provided with a leading edge directed at an interface between the frost and the external portion of the heat transfer surface.

When the vaporizer includes at least one tube, the mechanical scraper may be configured to conform to the shape of the external heat transfer surface of the tube. In this form, each tube may include a plurality of radial fins, and at least a portion of the mechanical scraper may be arranged on one or all of the radial fins and correspondingly shaped to fit snugly therearound with a minimal clearance between the mechanical scraper and the exterior heat transfer surface of the radial fins. The minimal clearance between the mechanical scraper and the exterior heat transfer surface of the radial fins may be in the range of 0.1 to 2 mm.

In one form, the mechanical scraper is arranged to travel laterally relative to the external portion of the heat transfer surface.

The mechanical scraper may be one of a plurality of mechanical scrapers.

In one form, the mechanical scraper is heated. If desired, the mechanical scraper may be heated to a sufficiently high temperature so as to melt the frost during removal. The frost removed using the mechanical scraper may be melted to form water that is collected under the action of gravity into a collection tray located towards a lowermost end of the vaporizer.

According to a third aspect of the present invention there is provided a process for regasifying a cryogenic liquid to gaseous form substantially as herein described with reference to and as illustrated in the accompanying representations.

According to a fourth aspect of the present invention there is provided an apparatus for regasifying a cryogenic liquid to gaseous form substantially as herein described with reference to and as illustrated in the accompanying representations.

### BRIEF DESCRIPTION OF THE DRAWINGS

In order to facilitate a more detailed understanding of the nature of the invention several embodiments of the present invention will now be described in detail, by way of example only, with reference to the accompanying drawings, in which:

FIG. 1 is a schematic side view of the Regasification LNG Carrier (RLNGC) provided with an onboard regasification facility for continuous regasification of LNG stored onboard the RLNGC to natural gas which is transferred via a marine riser associated with a sub-sea pipeline to shore;

FIG. 2 is a flow chart illustrating one embodiment of the regasification facility including an atmospheric vaporizer through which LNG is circulated for direct heat transfer with ambient air;

FIG. 3 is a cross-sectional view of a finned tube for use in the vaporizer of FIG. 4 or 5;

FIG. 4a is an isometric view of one embodiment of a four bundle vaporizer including collection tray;

FIG. 4b is an isometric view of a single pass vaporizer including an inlet manifold and an outlet manifold;

FIG. 5a is a cross-sectional view through four tubes of an atmospheric vaporizer illustrating the flow of fluid through the tubes of a multi-pass;

FIG. 5b is a cross-section view through four tubes of a single pass atmospheric vaporizer illustrating the flow of fluid through the tubes;

FIG. 6a illustrates one embodiment of a mechanical scraper correspondingly shaped to match the shape of the finned tube of FIG. 3;

FIG. 6b is an isometric view of the mechanical scraper of FIG. 6a fitted in use on a finned tube showing the mechanical removal of frost in use; and,

FIG. 7 illustrates another embodiment of the regasification facility including an atmospheric vaporizer through which an intermediate fluid is circulated for heat transfer with ambient air, the heated intermediate fluid then being used to transfer heat to vaporizer LNG to form natural gas.

### DETAILED DESCRIPTION

Particular embodiments of the method and apparatus for regasification of a cryogenic fluid to gaseous form using ambient air as the primary source of heat for vaporization are now described, with particular reference to the offshore regasification of liquefied natural gas (“LNG”) aboard an LNG Carrier, by way of example only. The present invention is equally applicable to use for regasification of other cryogenic liquids and also equally applicable to an onshore regasification facility or for use on a fixed offshore platform or barge. The terminology used herein is for the purpose of describing particular embodiments only, and is not intended to limit the scope of the present invention. Unless defined otherwise, all technical and scientific terms used herein have the same meanings as commonly understood by one of ordinary skill in the art to which this invention belongs. In the drawings, it should be understood that like reference numbers refer to like members.

Throughout this specification the term “RLNGC” refers to a self-propelled vessel, ship or LNG carrier provided with an onboard regasification facility which is used to convert LNG to natural gas. The RLNGC can be a modified ocean-going LNG vessel or a vessel that is custom or purpose built to include the onboard regasification facility.

The term “vaporizer” as used herein refers to a device which is used to convert a liquid into a gas. An “atmospheric vaporizer” as used herein refers to a device which is used to convert a liquid into a gas using atmospheric air as the primary source of heat.

The term “ice” as used herein refers to a solid layer of frozen water. The term “frost” refers to water vapor in the atmosphere that has frozen into unconsolidated crystals that deposit on a cold surface. In contrast to ice, frost can be readily removed from the cold surface by running a hand over the surface as the unconsolidated crystals are loosely bonded to each other. Ice, on the other hand, can only be removed from a surface by melting or delaminating.

The term “cryogenic liquid” as used herein refers to a liquid which has an atmospheric boiling point below 200 Kelvin (−73° C.).

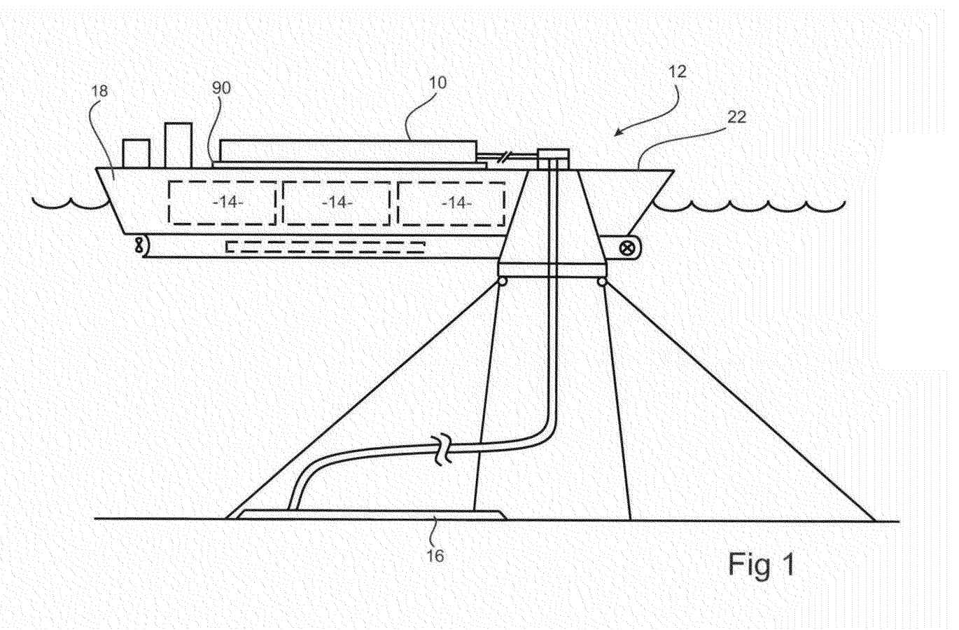

A first embodiment of the process and system of the present invention is now described with reference to FIGS. 1 to 6. In this first embodiment, a regasification facility 10 is provided onboard an RLNGC 12 and is used to regasify LNG that is stored aboard the RLNGC 12 in one or more cryogenic storage tanks 14. The onboard regasification facility 10 uses ambient air as the primary source of heat for regasification of the LNG to form natural gas. Ambient air is used (instead of heat from burning of fuel gas) as the primary source of heat for regasification of the LNG to keep emissions of nitrous oxide, sulphur dioxide, carbon dioxide, volatile organic compounds and particulate matter to a minimum. The natural gas produced using the onboard regasification facility 10 is transferred to a sub-sea pipeline 16 for delivery of the natural gas to an onshore gas distribution facility (not shown).

In one embodiment of the present invention, LNG is stored aboard the RLNGC in a plurality of storage tanks 14, each storage tank 14 having a gross storage capacity in the range of 30,000 to 50,000 m³. The RLNGC has a supporting hull structure 18 capable of withstanding the loads imposed from intermediate filling levels in the storage tanks 14 when the RLNGC is subject to harsh, multi-directional environmental conditions. The storage tank(s) 14 onboard the RLNGC are robust to or reduce sloshing of the LNG when the storage tanks are partly filled or when the RLNGC is riding out a storm whilst moored. To reduce the effects of sloshing, the storage tank(s) 14 are provided with a plurality of internal baffles or a reinforced membrane. The use of membrane storage tanks or prismatic storage tanks allows more space on the deck of the RLNGC for the regasification facility. Self supporting spherical cryogenic storage tanks, for example Moss type tanks, can be used when the RLNGC is fitted with the onboard regasification facility of the present invention.

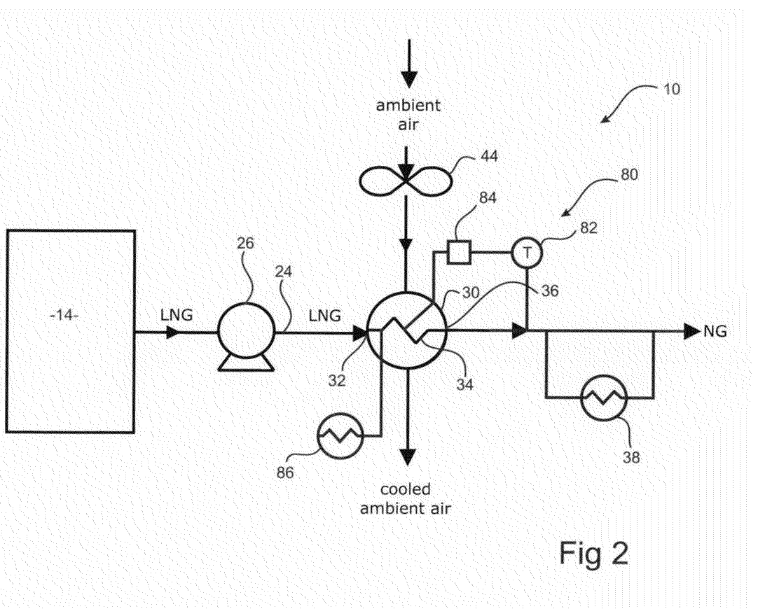

Referring to FIG. 2, LNG from the storage tank 14 is conveyed to the regasification facility 10 at the required send-out pressure through a high pressure onboard piping system 24 using at least one cryogenic send-out pump 26. The capacity of the send-out pump 26 is selected based upon the type and quantity of vaporizers 30 installed in the regasification facility 10, the surface area and efficiency of the vaporizers 30 and the degree of redundancy desired. They are also sized such that the RLNGC can discharge its cargo at a conventional import terminal at a rate of 10,000 m³/hr (nominal) with a peak in the range of 12,000 to 16,000 m³/hr.

In the illustrated embodiment of FIG. 2, the LNG is directed to flow into the tube-side inlet 32 of an atmospheric vaporizer 30. The LNG is vaporized as it passes through the tubes 34 of the vaporizer 30 to form natural gas which exits the vaporizer 30 through the tube-side outlet 36. If the natural gas which exits the tube-side outlet 36 of the vaporizer 30 is not already at a temperature suitable for distribution into the sub-sea pipeline 16, its temperature and pressure can be boosted by directing some or all of the natural gas through a supplemental heater 38. Suitable sources of heat for the supplemental heater 38 include one or more of: heat from engine cooling, waste heat recovery from power generation facilities and/or electrical heating from excess power from the power generation facilities, an exhaust gas heater; an electric water or fluid heater; a propulsion unit of the ship (when the regasification facility is onboard an RLNGC); a diesel engine; or a gas turbine propulsion plant.

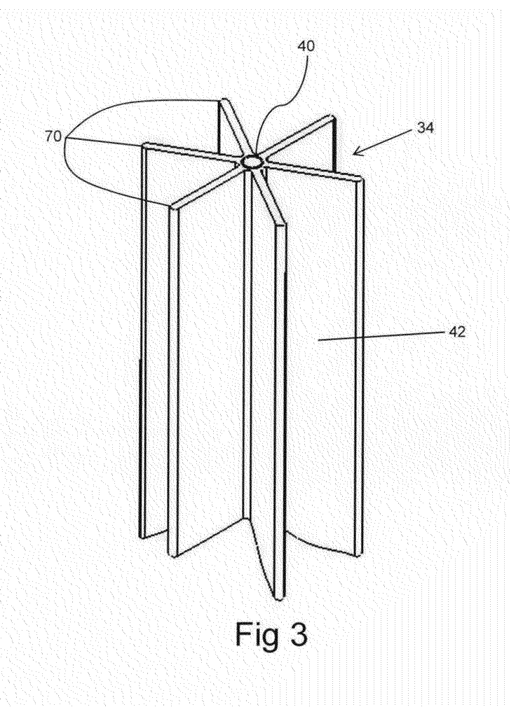

With reference to FIG. 3, the LNG is regasified to form natural gas as it flow through the internal hollow bore 40 of the tubes 34 of the vaporizer by heat exchange with ambient air acting on the exterior heat transfer surfaces 42 of each tubes 34. The LNG is warmed by the ambient air as a function of the temperature differential between the ambient air and the temperature and flow rate of the LNG through the tubes 34 of the vaporizer 30. Each tube 34 is constructed from a material having good heat transfer characteristics, with aluminium, stainless steel or Monel being preferred materials. Heat transfer between the ambient air and the LNG can be assisted, if desired, through the use of forced draft fans 44 arranged to direct the flow of air towards the atmospheric vaporizer 30, preferably in a downward direction.

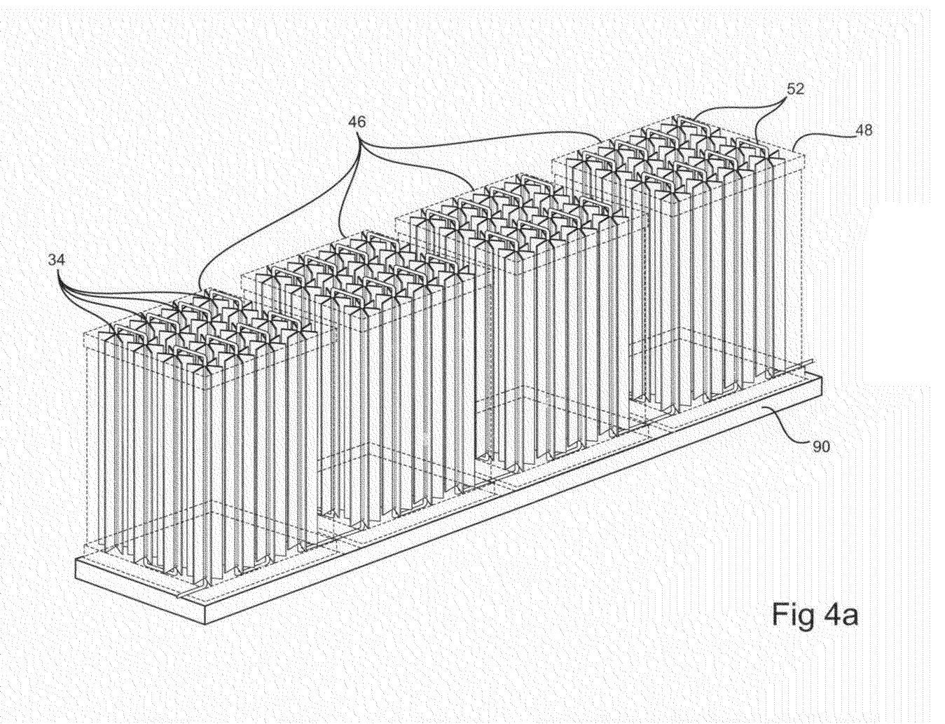

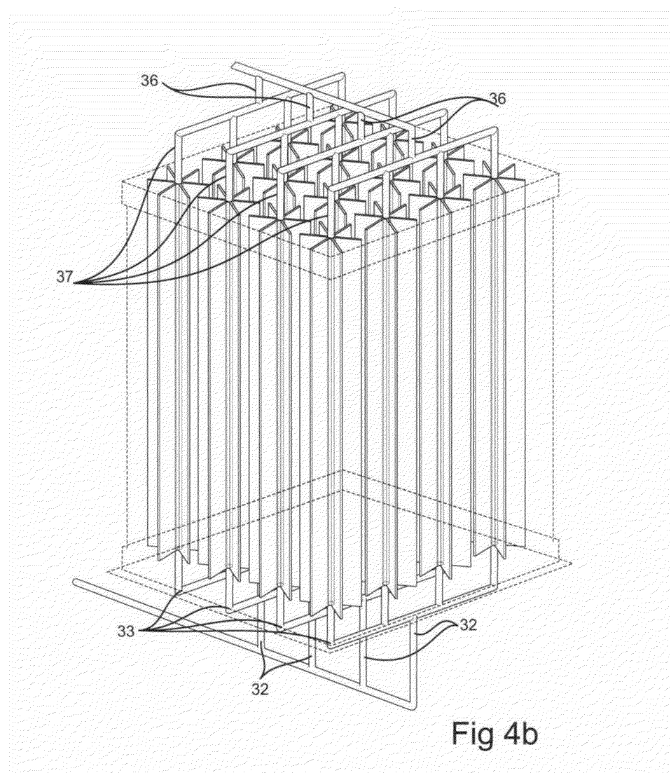

FIG. 4 illustrates an atmospheric vaporizer 30 including a plurality of passes 46, the passes being spaced apart from one another and arranged in a square, rectangular or triangular array. The passes 46 may be connected in series or parallel or in a combination of series and parallel configurations. The number of passes 46 the fluid flows through and the path of the fluid flow through the vaporizer 30 (i.e. series or parallel or a combination of series and parallel), will depend on various factors, such as end use temperature and flow rate requirements, ambient temperature, heat transfer characteristics, pressure drop factors and other considerations which are known to those skilled in the art. It is thus equally permissible for the atmospheric vaporizer 30 to have only a single pass 46. For best results, the tubes 34 are vertically oriented, being held in place by suitable supports 48 with clearance being provided between the vaporizer 30 and the surface upon which the vaporizer 30 rests.

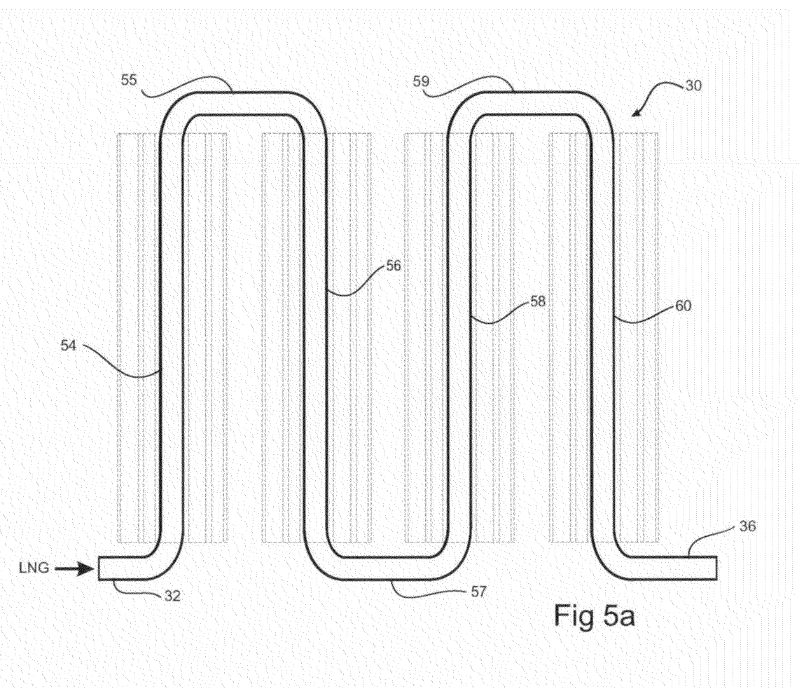

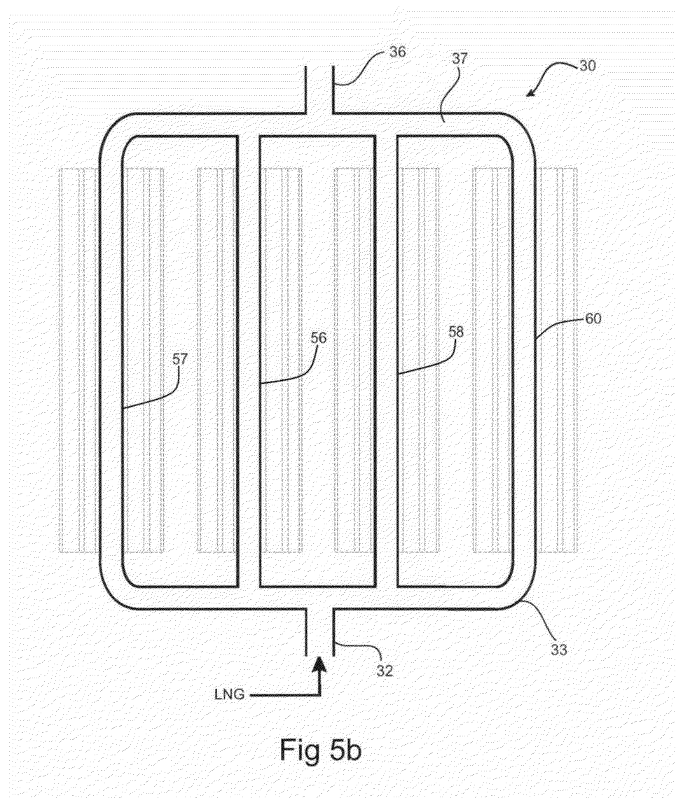

Each pass 46 comprises a plurality of tubes 34 connected together in any suitable manner. By way of example, in the embodiment illustrated in FIG. 4a and FIG. 5a, four tubes 34 of a multi-pass vaporizer 30 are shown to illustrate how the cryogenic fluid is caused to flow through the vaporizer 30. In this example, the LNG enters the tube-side inlet 32 of the vaporizer 30 at the bottom of a first tube 54, travels up the first tube 54 and over through a first connector 55 to an adjacent second tube 56, down the second tube 56 and across through a second connector 57 to the adjacent third tube 58, up the third tube 58 and over through a third connector 59 to the adjacent fourth tube 60, down the fourth tube 60 in series and out of the tube-side outlet 36 where it exits the vaporizer 30 as natural gas at a temperature appropriate for a nominated end use. An alternative is illustrated in FIGS. 4b and 5b for which like reference numerals refer to like parts. In this embodiment, the LNG enters the tube-side inlet 32 of the vaporizer 30 and is directed to flow through each of the first, second, third and fourth tubes 54, 56, 58 and 60, respectively, in a single pass to form natural gas which leaves the vaporizer via the tube-side outlet 36. The tube-side inlet 32 includes an inlet manifold 33 for distributing the cryogenic fluid into each of the first, second, third and fourth tubes 54, 56, 58 and 60, respectively. The tube-side outlet 36 includes an outlet manifold 37 for receiving the gas from in each of the first, second, third and fourth tubes 54, 56, 58 and 60, respectively, and directing the gas to flow out of the vaporizer 30 through the tube-side outlet 36.

With reference to FIG. 3, each tube 34 has a central bore 40 through which LNG is caused to flow. Each tube 34 has a finned exterior heat transfer surface 42, and, optionally a finned interior surface, an inlet for fluid flow at one end, an outlet for fluid flow at the other distal end, and a sufficient wall thickness to contain the LNG at the requisite send-out pressure. Each tube 34 is provided with a plurality of radial fins 70 extending along the length of the tube, the radial fins 70 being spaced substantially equidistant from each other around the circumference of the tube 34. By way of example, when the tube 34 is provided with six radial fins, each fin 70 is arranged around the circumference of the tube 34 at an angle of approximately 60 degrees to each other. The radial fins are used to increase the effective surface area for heat exchange being the cryogenic fluid and the ambient air, as well as to provide additional mechanical support to the tubes. As the ambient air transfers heat to the LNG to vaporize it to natural gas, the ambient air itself is cooled. Moisture in the air condenses on the exterior heat transfer surfaces 42 of the vaporizer 30.

Using the processes of the prior art, a layer of ice builds up on the portion of the exterior surface of the vaporizer where the temperature falls below the freezing point of water. Over time, using the processes of the prior art, the layer of ice may completely fill the space between adjacent fins on the external surface of the tubes as well as the space between adjacent tubes. In contrast, using the process of the present invention, the layer of ice is not allowed to accumulate on the external surfaces of the ambient air vaporizer. Instead, mechanical defrosting is conducted on a repetitive basis to continuously defrost the external heat transfer surfaces of the vaporizer to prevent ice build-up.

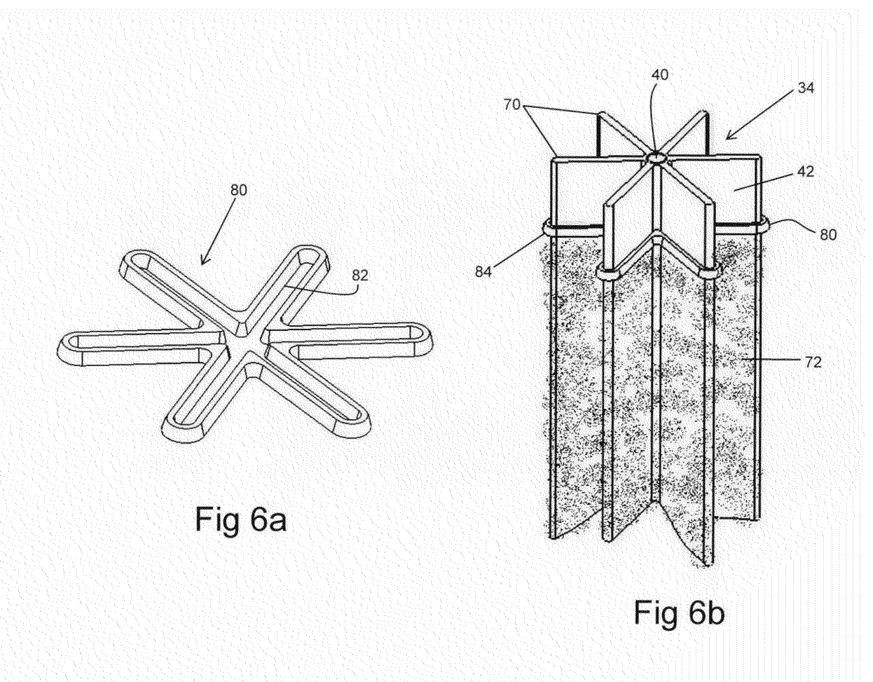

The present invention is based in part on the realization that the water that freezes onto the external heat transfer surface 42 of an ambient air vaporizer is initially present in the form of a layer of frost (illustrated by shading in FIG. 6b and labeled with reference numeral 72) which is readily removed by the application of a shear force at the interface of the layer of frost 72 and the external heat transfer surface 42 using a mechanical scraper 80 (best seen in FIG. 6a). The mechanical scraper 80 is arranged to move slowing laterally up and down the fins 70 of each tube 34 to sweep the frost from the external heat transfer surface 42 before such frost can consolidate into a solid layer of ice. If desired, the mechanical scraper 80 can be heated so as to melt the frost removed during this operation as well as any ice that may have formed on the external heat transfer surface. When heating is used, some of the frost that is removed using the mechanical scraper 80 is melted to form water that is collected under the action of gravity into a collection tray 90 located towards the lowermost end of the vaporizer.

Using the mechanical scraper of the present invention for continuous defrosting, a billion cubic foot per day regasification facility would need only 9 to 10 vaporizers compared to about 45 to 50 vaporizers required to support a 4 to 8 hour run time using conventional prior art ambient air vaporizers. Advantage is still taken of the significant increase in the average heat transfer rate that is achieved when ice build up is minimized due to the short run time that can be maintained with mechanical de-icing. Using the process and apparatus of the present invention, the vaporizers can be provided at an increased packing density with respect to the number of finned tubes per pass. By way of example, a standard vaporizer with 196 tubes can be increased to 324 tubes. This increase alone coupled with a corresponding increase in air flow rate and reduced run time from 4-8 hours to less than 1 hour, could result in a 50% increase in vaporizer capacity.

It is to be understood that the process of the present invention is not one in which the ice is removed from the external surfaces of the vaporizer through complete melting of the ice by external application of heat. On the contrary, shear force is applied to the interface of the frost and the external heat transfer surfaces 42 of the tubes 34 to essentially “sweep” the frost from the external heat transfer surfaces 42 of the vaporizer 30. The layer of frost 72 is removed repeatedly yet intermittently in this way, so that ambient air can come into contact with the external heat transfer surfaces 42 of the vaporizer to maximize the exchange of heat between the ambient air and the LNG being circulated through the tubes of the vaporizer.

In one form of the present invention, each vaporizer is provided with one or a plurality of mechanical scrapers 80 that operate on an intermittent or continuous basis to ensure that the low density layer of frost is not able to develop into a hard layer of dense ice. Each mechanical scraper 80 is used for applying a shear force to a layer of frost that forms, in use, on at least that external portion of the heat transfer surface 42 exposed to the atmosphere, whereby defrosting is achieved without the need to discontinue circulating the cryogenic fluid or the intermediate fluid through the vaporizer. Each mechanical scraper is arranged to travel laterally relative to the external heat transfer surface and may, by way of example, be provided with a leading edge 82 directed at the interface between the frost 72 and the external portion 84 of the heat transfer surface 42 to facilitate scraping. For best results, at least a portion of each mechanical scraper 80 is arranged on one or all of the radial fins and correspondingly shaped to fit snugly therearound with minimal clearance (in the order of but not limited to 0.1 to 2 mm) between the mechanical scraper and the exterior heat transfer surface of the radial fins.

In one form of the present invention, the mechanical scraper 80 is heated to assist in melting any dense ice that may form even within the short run times of less than an hour that may be used for the vaporizers of the present invention. Whilst a short run time is most efficient to increase the capacity of a vaporizer, the apparatus of the present invention can be used for a 4-8 hour run time or as desired by the operator. It will still provide the benefit of eliminating the need to use standby vaporizers that would otherwise normally be in defrost mode of operation using prior art standard configurations When used, the heat from the mechanical scraper is sufficient to melt the thin layer of ice, if present. It is to be clearly understood, that in its most basic form, the mechanical scraper(s) are used to ensure that a dense layer of ice is never able to form.

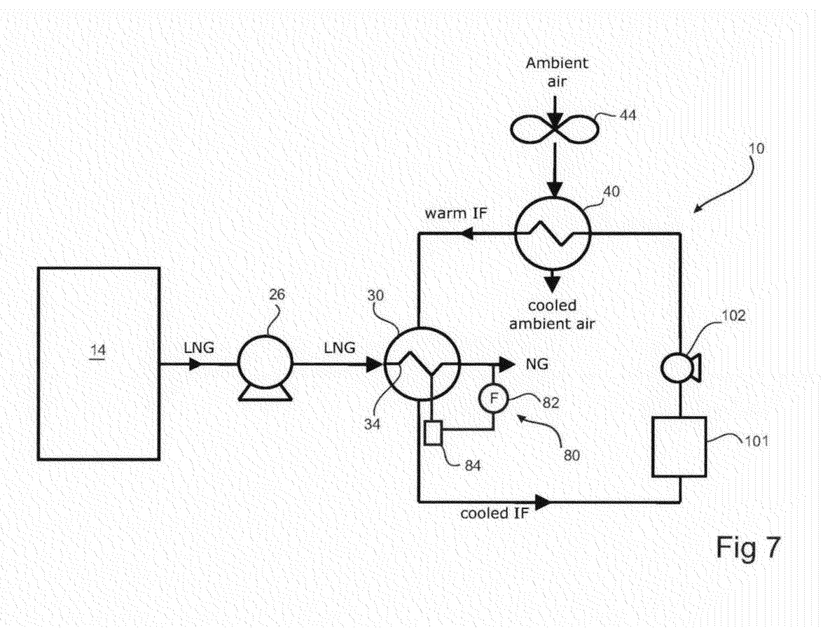

An alternative embodiment of the onboard regasification facility 14 is illustrated in FIG. 7 for which like reference numerals refer to like parts, in which an intermediate fluid is directed to flow through the tubes 34 of an ambient air heat exchanger 40, the intermediate fluid being heated by heat exchange with ambient air acting on the exterior heat transfer surfaces of the ambient air heat exchanger 40. The heated intermediate fluid is then circulated to the vaporizer 30 in which the LNG is regasified to natural gas through heat exchange with the heated intermediate fluid. In this embodiment, the cooled intermediate fluid which exits the vaporizer 30 is directed to a surge tank 100 and then pumped back to the ambient air heat exchanger 40 using intermediate fluid pump 102. In this embodiment, frost deposits on the exterior heat transfer surfaces of the ambient air heat exchanger 40 when the temperature at the exterior heat transfer surface is below the freezing temperature of the water present in the ambient air. Suitable intermediate fluids for use in the process and apparatus of the present invention include: glycol (such as ethylene glycol, diethylene glycol, triethylene glycol, or a mixture of them), glycol-water mixtures, methanol, propanol, propane, butane, ammonia, formate, tempered water or fresh water or any other fluid with an acceptable heat capacity, freezing and boiling points that is commonly known to a person skilled in the art. It is desirable to use an environmentally more acceptable material than glycol for the intermediate fluid. In this regard, it is preferable to use an intermediate fluid which comprises a solution containing an alkali metal formate, such as potassium formate or sodium formate in water or an aqueous solution of ammonium formate. Alternatively or additionally, an alkali metal acetate such as potassium acetate, or ammonium acetate may be used. The solutions may include amounts of alkali metal halides calculated to improve the freeze resistance of the combination, that is, to lower the freeze point beyond the level of a solution of potassium formate alone.

The advantage of using an intermediate fluid with a low freezing point is that the cold intermediate fluid which exits the shell-side outlet 40 of the vaporizer 30 can be allowed to drop to a temperature in the range of −20 to −70° C., depending on the freezing point of the particular type of intermediate fluid selected. Using the process and apparatus of the present invention, frost forms on a portion of the heat transfer surface of the ambient air heat exchanger and this frost is removed on a repetitive intermittent basis using a mechanical scraper to apply a shear force applied along the external heat transfer surfaces to sweep the frost away.

Heat transfer between the ambient air and the intermediate fluid can be assisted through the use of forced draft fans 44 arranged to direct the flow of air towards the heat exchangers 40 as described above.

Whilst only one vaporizer is illustrated in FIG. 2 and only one ambient air heat exchanger is illustrated in FIG. 7, it is to be understood that the regasification facility 10 can equally comprise a larger number of vaporizers 30 or heat exchangers 40 to suit the capacity of natural gas to be delivered from the regasification facility 10. By way of example, to provide sufficient surface area for heat exchange, the vaporizer 30 may be one of a plurality of vaporizers arranged in a variety of configurations, for example in series, in parallel or in banks. The ambient air vaporizer 30 can be a finned tube heater, a bent-tube fixed-tube-sheet exchanger, a spiral tube exchanger, a plate-type heater, or any other heat exchanger commonly known by those skilled in the art that meets the temperature, volumetric and heat absorption requirements for quantity of LNG to be regasified. It is preferable that the ambient air vaporizer is of a type which is best adapted to withstanding the additional gravitational bending loads generated by the presence of the mechanical scraping means and related guide rails, and in this regard, vertical tube bundles are preferred to horizontal tube bundles. The use of vertical tube passes is also better suited to reducing the overall footprint of the regasification facility 10. The vaporizers 30, heat exchangers and fans 44 are designed to withstand the structural loads associated with being disposed on the deck of the RLNGC 12 during transit of the vessel at sea including the loads associated with motions and possibly green water loads as well as the loads experienced whilst the RLNGC is moored offshore during regasification.

The process and apparatus of the present invention provides a number of advantages over the prior art including the following:
a) the need to shut down vaporizers for defrosting is avoided;
b) the need to provide redundant vaporizers is overcome as defrosting can be managed without disrupting the flow of LNG through the regasification facility, reducing the overall footprint of the regasification and avoiding the extra expense of providing redundant vaporizers;
c) the number of vaporizers required to achieve a design send out rate is reduced, leading to a reduction in overall cost;
d) the power required to maintain air flow is minimized compared with the power required when ice is allowed to build up;
e) the overall footprint of the regasification facility is reduced, resulting in a reduction in visibility issues on an RLNGC;
f) safety is improved with less inventory in case of loss of containment or fire; and,
g) it is easier to install and maintain for both onshore and offshore applications.

Now that several embodiments of the invention have been described in detail, it will be apparent to persons skilled in the relevant art that numerous variations and modifications can be made without departing from the basic inventive concepts. For example, whilst an RLNGC has been used to illustrate the application of the technology, this apparatus and process can be installed on a land based regasification, other cryogenic facilities, other offshore facilities both fixed and floating. All such modifications and variations are considered to be within the scope of the present invention, the nature of which is to be determined from the foregoing description and the appended claims.

All of the patents cited in this specification, are herein incorporated by reference.

What is claimed:

1. A process for regasifying a cryogenic liquid to gaseous form, the process comprising the steps of:
(a) transferring heat from ambient air to the cryogenic liquid across a heat transfer surface by circulating the cryogenic liquid or an intermediate fluid through an atmospheric vaporizer, wherein the ambient air and the cryogenic fluid or intermediate fluid are not in direct contact; and,
(b) mechanically scraping an external portion of the heat transfer surface exposed to the atmosphere to remove frost from said external portion of the heat transfer surface, wherein defrosting is achieved without the need to discontinue circulating the cryogenic fluid or the intermediate fluid through the atmospheric vaporizer.

2. The process of claim 1, wherein step (b) comprises applying a shear force to remove a layer of frost that forms, in use, on the external portion of the heat transfer surface exposed to the atmosphere.

3. The process of claim 1, wherein step (b) is conducted on an intermittent basis.

4. The process of claim 1, wherein step (b) is conducted on a continuous basis.

5. The process of claim 1, wherein the vaporizer comprises a plurality of tubes and step (b) comprises mechanically scraping an external portion of the heat transfer surface of each of the plurality of tubes.

6. The process of claim 1, wherein each tube includes a plurality of radial fins, and wherein step (b) comprises mechanically scraping an external portion of the heat transfer surface of each of the radial fins.

7. The process of claim 1, further comprising the step of applying heat during step (b).

8. The process of claim 1, wherein the intermediate fluid is selected from the group consisting of a glycol, a glycol-water mixture, methanol, propanol, propane, butane, ammonia, a formate, fresh water and tempered water.

9. The process of claim 1, wherein the atmospheric vaporizer comprises a plurality of passes, the passes being spaced apart from one another and arranged in an array, and each pass is provided with one or a plurality of mechanical scrapers that operate on an intermittent or continuous basis to perform step (b).

10. The process of claim 9, wherein each pass has a vertical orientation and adjacent passes are connected in at least one of in series configurations and in parallel configurations.

11. The process of claim 1, wherein the cryogenic fluid is LNG.

12. An apparatus for regasifying a cryogenic liquid to gaseous form, the apparatus comprising:
an atmospheric vaporizer to transfer heat from ambient air to the cryogenic liquid across a heat transfer surface by circulating the cryogenic liquid or an intermediate fluid through the atmospheric vaporizer, wherein the ambient air and the cryogenic fluid or intermediate fluid are not in direct contact; and,
a mechanical scraper to mechanically scrape an external portion of the heat transfer surface exposed to the atmosphere so as to remove frost from said external portion of the heat transfer surface, wherein defrosting is achieved without the need to discontinue circulating the cryogenic fluid or the intermediate fluid through the atmospheric vaporizer.

13. The apparatus of claim 12, wherein the mechanical scraper applies a shear force to remove a layer of frost that forms, in use, on the external portion of the heat transfer surface exposed to the atmosphere.

14. The apparatus of claim 12, wherein the mechanical scraper is operated on an intermittent basis.

15. The apparatus of claim 12, wherein the mechanical scraper is operated on a continuous basis.

16. The apparatus of claim 12, wherein the mechanical scraper is provided with a leading edge directed at an interface between the frost and the external portion of the heat transfer surface.

17. The apparatus of claim 12, wherein the vaporizer includes at least one tube and the mechanical scraper is configured to conform to the shape of the external heat transfer surface of the tube.

18. The apparatus of claim 12, wherein the vaporizer includes at least one tube, each tube including a plurality of radial fins, and at least a portion of the mechanical scraper is arranged on one or all of the radial fins and correspondingly shaped to fit snugly therearound with a minimal clearance between the mechanical scraper and the exterior heat transfer surface of the radial fins.

19. The apparatus of claim 18, wherein the minimal clearance between the mechanical scraper and the exterior heat transfer surface of the radial fins is in the range of 0.1 to 2 mm.

20. The apparatus of claim 12, wherein the mechanical scraper is arranged to travel laterally relative to the external portion of the heat transfer surface.

21. The apparatus of claim 12, wherein the mechanical scraper is one of a plurality of mechanical scrapers.

22. The apparatus of claim 12, wherein the mechanical scraper is heated.

23. The apparatus of claim 12, wherein the mechanical scraper is heated to a sufficiently high temperature so as to melt the frost during removal.

24. The apparatus of claim 12, wherein the frost removed using the mechanical scraper is melted to form water that is collected under the action of gravity into a collection tray located towards a lowermost end of the vaporizer.
